(19) United States
(12) Patent Application Publication
(10) Pub. No.: US 2007/0011615 A1
(43) Pub. Date: Jan. 11, 2007

(54) Optical disc reproducing apparatus

(75) Inventor: Ryuji Ikeda, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/441,158

(22) Filed: May 26, 2006

(30) Foreign Application Priority Data
May 31, 2005 (JP) 2005-158604

(51) Int. Cl. G06F 17/00

(52) U.S. Cl. 715/730

(57) ABSTRACT

A selected file on an optical disc is read to obtain the file information thereof, and if, based on the obtained file information, the selected file is judged to be a reproducible file, it is decoded to be displayed as a slide show image. When the image starts to be displayed, its display time starts to be counted and also the next file is read to obtain the file information thereof. When the display time is judged to have reached a predetermined time and if the next file is judged to be a reproducible file, the next file is decoded to be displayed as the next slide show image. This permits immediate switching to the display of the next image after the lapse of the predetermined time.

This application is based on Japanese Patent Application No. 2005-158604 filed on May 31, 2005, the contents of which are hereby incorporated by reference.

### BACKGROUND OF THE INVENTION

1. Field of the Invention

The present invention relates to an optical disc reproducing apparatus for reproducing information recorded on an optical disc. In particular, the present invention relates to an optical disc reproducing apparatus having a slide-show function for displaying one image after another at predetermined time intervals.

2. Description of Related Art

Optical disc reproducing apparatuses such as DVD players are liable to have a smaller memory capacity for the sake of cost reduction that has recently been eagerly pursued. Since an optical disc reproducing apparatus having a reduced memory capacity cannot temporarily store a great amount of information, when image files based on a data format such as JPEG (Joint Photographic Experts Group) are displayed in a slide show, for one image after another, its file is read and the image is displayed. In a conventional optical disc reproducing apparatus, at the moment that a file is read and an image is displayed, its display time (reproduction time) starts to be measured and, when the time for switching images is reached (for example, five or ten seconds thereafter), the next file is read.

FIG. 4 is a flow chart illustrating how the slide-show function operates in a conventional optical disc reproducing apparatus. With reference to the flow chart, how the slide-show function operates in a conventional optical disc reproducing apparatus will be described.

First, an optical disc on which files to be displayed in a slide show are recorded is played. Then, through operation of a remote control, files to be reproduced and displayed in the slide show are selected (step N1). Next, one of the selected files is read so as to obtain the file information thereof (step N2). Then, based on the obtained file information, it is judged whether or not the file is reproducible (step N3). If it is judged that the file is reproducible, it is decoded (step N4).

After the reproducible file is decoded, based on the decoded data, a slide show image is displayed (step N5). At the moment that the slide show image starts to be displayed, its display time starts to be counted (step N6). Then, whether or not the display time has exceeded the time set by the user is judged (step N7).

If, in step N7, the display time is judged to have reached the set time, the file information of the next file is obtained (step N8). Then, step N9 is performed. In step N9, if, based on the obtained file information of the next file, it is judged that the next file is reproducible, the next file is decoded (step N10). After the next reproducible file is decoded, an image based on the decoded data is displayed in the slide show. If, in step N9, it is judged that the next file is unreproducible, then the second next file is read to obtain the file information thereof, and thereafter, the same steps as described above are repeatedly performed.

As described above, in a conventional optical disc reproducing apparatus, at the moment that a file is read and an image is displayed, its display time starts to be measured and, when the time for switching images comes, the next file is read. Here, disadvantageously, if it takes longer time to read the next file, the display of the image is delayed, causing the display time of the previous slide show image to vary. The reading time of a file varies depending on its file size, that is, it takes a longer time to read a larger file.

In short, in a conventional optical disc reproducing apparatus, when an image such as a JPEG image is displayed, the time taken to display it differs according to the file size. The difference may amount to, for example, almost 10 seconds. Thus, the display time varies form one image to another, and this is stressful to the user.

JP-A-2005-39359 discloses an image reproducing apparatus. In the image reproducing apparatus, while image data is displayed on the display portion, other image data related to the image data currently displayed is detected from the memory portion. This makes it possible to make use of idle-time to achieve effective detection of related image data. No special consideration, however, is given to the display time of a slide show image, that is, no control is performed to keep the display time as set.

JP-A-2005-79822 discloses another example of a conventional image reproducing apparatus. This image reproducing apparatus has: an image control portion for controlling photo images corresponding to still image data files; and an image display control portion for controlling the display of photo images. These two portions are operated parallel to permit photo images to be displayed in a slide show without making the user aware of the time required to read still image data files from a portable recording medium. In the image reproducing apparatus also, however, no special consideration is given to the display time of a slide show image, that is, no control is performed to keep the display time as set.

### SUMMARY OF THE INVENTION

The present invention has been made to solve the conventionally encountered problems discussed above, and it is an object of the present invention to provide an optical disc reproducing apparatus that is capable of, when displaying image files conforming to an image format such as JPEG in a slide show, switching images at constant time intervals irrespective of their file size.

To achieve the above object, according to the present invention, an optical disc reproducing apparatus that reproduces information recorded on an optical disc is provided with a system controller that controls such that: while a display time of a slide show image being displayed based on a selected file is counted, a next file is read in advance; and as soon as the display time has reached a set time, a next slide show image is displayed based on the next file.

With this configuration, while the display time of a slide show image is being counted, the next file can be read beforehand, and this permits immediate switching to the display of the next image. Hence, when image files conforming to an image format such as JPEG are displayed in a slide show, images can be switched at constant time intervals irrespective of their file size. This enables the user to enjoy images without feeling any stress.

According to the present invention, in the above configured optical disc reproducing apparatus, the system controller is provided with: file information obtaining means for reading a selected file to obtain file information thereof; reproducible file judging means for judging, based on the obtained file information, whether or not the selected file is reproducible; decoding instructing means for instructing a video decoder to decode the selected file if the selected file is judged to be reproducible; image display means for making, after the selected file is decoded, a display device display a slide show image based on the decoded data; next file information obtaining means for starting, at a start of the display of the slide show image, to read a next file to obtain file information thereof; next reproducible file judging means for judging, based on the obtained next file information, whether or not the next file is reproducible; display time judging means for judging, by counting a display time after a slide show image started to be displayed on the display device by the image display means, whether or not the display time has reached a predetermined time; next file decoding instructing means for instructing the video decoder to decode the next file when the display time is judged to have reached the predetermined time and the next file is judged to be reproducible based on the file information thereof obtained by the next file information obtaining means; and next image display means for making, after the next file is decoded and when the display time is judged to have reached the predetermined time, the display device display a slide show image based on the next decoded data.

With this configuration, the system controller can: obtain file information; judge whether or not a file is reproducible; instruct to decode; display an image; obtain next file information; judge whether or not a next file is reproducible; and display the next image. Thus, it is possible to achieve control whereby, while the display time of a slide show image is being counted, the next file is read beforehand so that the next slide show image can be displayed immediately after the lapse of a predetermined time.

### BRIEF DESCRIPTION OF THE DRAWINGS

These and other objects and features of the present invention will be apparent from the following detailed description of preferred embodiments thereof taken in conjunction with the accompanying drawings, in which:

FIG. 1 is a block diagram showing the configuration of an optical disc reproducing apparatus embodying the present invention;

FIG. 2 is a diagram illustrating how, as time passes, the reading of files and the display of images from the files are processed by the slide-show function of the embodiment shown in FIG. 1;

FIG. 3 is a flow chart illustrating how the slide-show function of the embodiment operates; and

FIG. 4 is a flow chart illustrating how the slide-show function of a conventional optical disc reproducing apparatus operates.

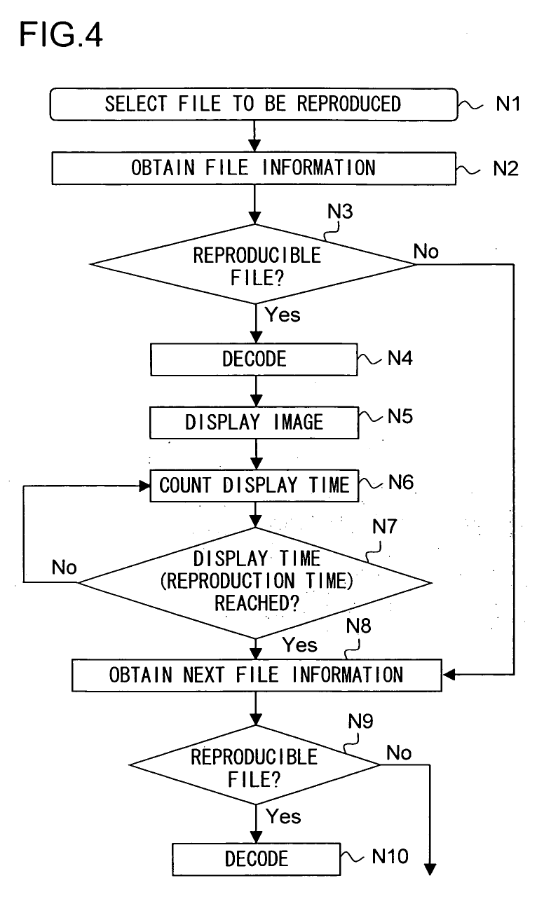

### DETAILED DESCRIPTION OF PREFERRED EMBODIMENTS

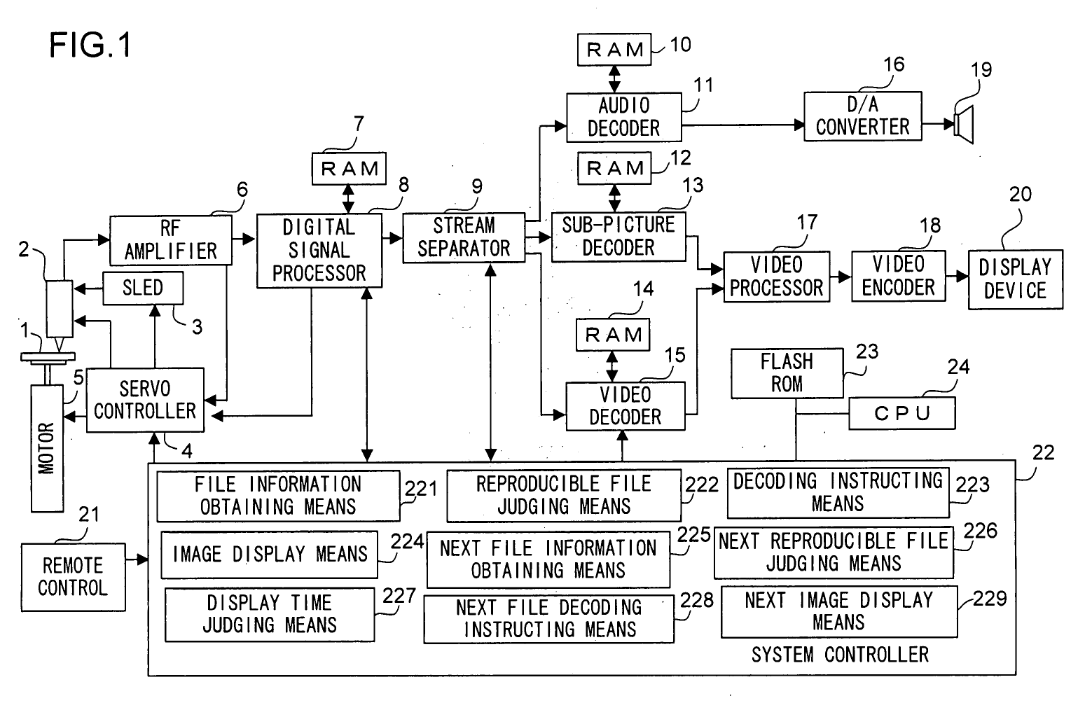

Hereinafter, the best mode of carrying out the present invention will be described in detail by way of embodiments shown in FIGS. 1 to 3. It should be understood, however, that these embodiments exemplify an optical disc reproducing apparatus in which to realize the technological ideas of the present invention and that the present invention is not meant to be limited to these embodiments. It should also be understood that the present invention may be equally practiced with many modifications and variations within the technological ideas described in the claims.

An optical disc reproducing apparatus according to the present invention is provided with: a spindle motor 5 that turns an optical disc 1; an optical pickup 2 that emits laser light for reproducing information recorded on the optical disc 1 and that receives light reflected from the optical disc 1; a sled 3 that moves the optical pickup 2 in a radial direction of the optical disc 1; a system controller 22 that controls the apparatus as a whole; and a servo controller 4 that drives the spindle motor 5 and the sled 3 according to instructions from the system controller 22 and moves a focal position of the laser light in perpendicular and parallel directions with respect to a recording surface of the optical disc 1 by moving an objective lens (not shown) incorporated in the optical pickup 2.

The optical disc reproducing apparatus is further provided with: an RF amplifier 6 that, when the optical disc 1 is reproduced, amplifies an RF signal fed, as a readout signal, from the optical pickup 2; a digital signal processor 8 that converts the RF signal outputted from the RF amplifier 6 into digital data, then performs signal demodulation and error correction according to the data format of the optical disc 1, and then stores the resulting data in a RAM 7; and a stream separator 9 that, according to instructions from the system controller 22, separates audio data complying with the DVD-audio standard, sub-picture data, and video data from the data stream outputted from the digital signal processor 8.

The optical disc reproducing apparatus is further provided with: an audio decoder 11 to which is inputted the audio data outputted from the stream separator 9 and that performs predetermined decoding; a RAM 10 that temporarily stores data for the audio decoder 11 to perform decoding; a sub-picture decoder 13 to which is inputted the sub-picture data outputted from the stream separator 9 and that performs predetermined decoding; a RAM 12 that temporarily stores data for the sub-picture decoder 13 to perform decoding; a video decoder 15 to which is inputted the video data outputted from the stream separator 9 and that performs predetermined decoding; and a RAM 14 that temporarily stores data for the video decoder 15 to perform decoding.

The optical disc reproducing apparatus is further provided with: a video processor 17 that, according to instructions from the system controller 22, synthesizes the data outputted from the video decoder 15 and the data outputted from the sub-picture decoder 13; a video encoder 18 that converts the synthesized data outputted from the video processor 17 into a display video signal so as to permit a display device 20 to display a still image; and a D/A converter 16 that converts the data outputted from the audio decoder 11 into an analogue audio signal and then feeds it to a speaker 19.

The optical disc reproducing apparatus is further provided with a remote control 21 having various operation keys such as: a play key for instructing the system controller 22 to start reproduction; a stop key for instructing it to stop reproducing; and a navigation key for instructing it to select and display a still image.

The optical disc reproducing apparatus is further provided with: a flash ROM 23 that stores programs and data for controlling the individual components of the apparatus and the apparatus as a whole; and a CPU 24 that performs computation according to the programs and data stored in the flash ROM 23, thereby controlling the system controller 22.

The system controller 22 is provided with: file information obtaining means 221 for reading a selected file so as to obtain the file information thereof; reproducible file judging means 222 for judging, based on the obtained file information, whether or not the selected file is reproducible; decoding instructing means 223 for instructing the video decoder 15 to decode the selected file if the selected file is judged to be reproducible; image display means 224 for making, after the selected file is decoded, the display device 20 display a slide show image based on the decoded data; next file information obtaining means 225 for starting, at the start of the display of the slide show image, reading the next file to obtain the file information thereof.

The system controller 22 is further provided with: next reproducible file judging means 226 for judging whether or not the selected next file is reproducible based on the obtained file information thereof; display time judging means 227 for counting the display time having passed after a slide show image started to be displayed on the display device 20 by using the image display means 224 and thereby judges whether or not the display time has reached a predetermined time; next file decoding instructing means 228 for instructing the video decoder 15 to decode the next file if the display time is judged to have reached the predetermined time and if the next file is judged to be reproducible based on the file information thereof obtained by the next file information obtaining means 225; and next image display means 229 for making, after the next file is decoded, the display device 20 display a slide show image based on the decoded data if the display time is judged to have reached the predetermined time.

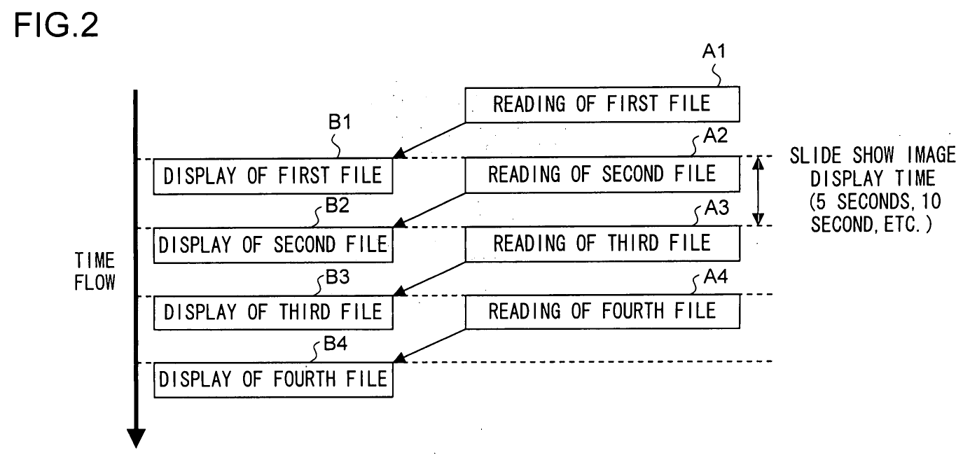

How, as time passes, the reading of files and the display of images therefrom are processed by the slide-show function will be described with reference to FIG. 2. In FIG. 2, in the reading A1 of a first file, the first file reproduced from the optical disc 1 and then selected is read. The first file is decoded and then the image display B1 of the first file is performed. More specifically, the digital signal processor 8 converts the RF signal from the optical pickup 2 that has read the first file recorded on the optical disc 1 into digital data, and then performs signal demodulation and error correction according to the data format of the optical disc 1, and then temporarily stores the resulting still image data and the like in RAM 7. The video decoder 15 decodes the still image data and makes, via the video encoder 18, the display device 20 display the slide show image based on the first file.

While the image display B1 of the first file is being performed, that is, during this file's share of the slide show, the reading A2 of a second file is performed and the second file is decoded. When the time for the previous file's share of the slide show (the display time per file, for example, 5 seconds, or 10 seconds) is up, the image display B2 of the second file is performed. While the image display B2 of the second file is being performed, the reading A3 of a third file is performed and the third file is decoded. When the time for the previous file's share of the slide show is up, the image display B3 of the third file is performed. While the image display B3 of the third file is being performed, the reading A4 of a fourth file is performed and the fourth file is decoded. When the time for the previous file's share of the slide show is up, the image display B4 of the fourth file is performed.

In a case where the time for each file's share of the slide show is five seconds or ten seconds, the reading of a file is performed during that period of five seconds or the ten seconds, and if the file is found to be reproducible, it is decoded to be ready to be displayed. This makes it possible to display an image immediately after the lapse of a period of 5 seconds or 10 seconds.

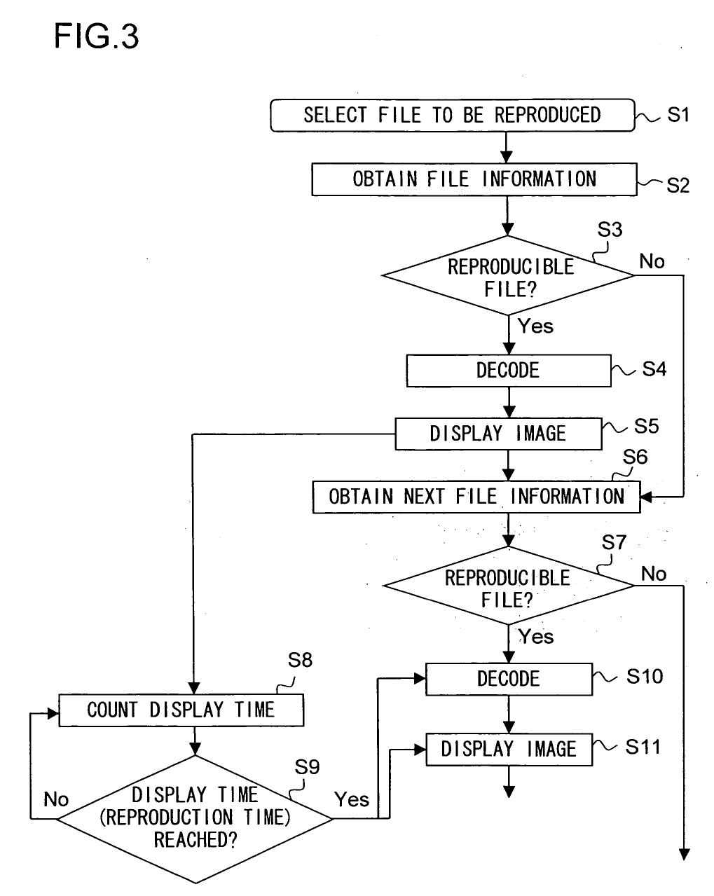

The operation of the slide show function will be described with reference to the flow chart shown in FIG. 3 and FIG. 1.

First, an optical disc 1 where files from which to present a slide show are recorded is started up. Then, through operation of the remote control 21, a file to be reproduced to be displayed in the slide show is selected (step S1). The file information obtaining means 221 of the system controller 22 reads the selected file to obtain the file information thereof (step S2). Then, based on the obtained file information, the reproducible file judging means 222 of the system controller 22 judges whether or not the selected file is a reproducible file (step S3). If the selected file is judged to be a reproducible file, the decoding instructing means 223 instructs the video decoder 15 to decode the selected file.

The reproducible file is decoded by the video decoder 15 (step S4). Then, the image display means 224 of the system controller 22 makes the display device 20 display a slide show image based on the decoded data (step S5). More specifically, the image display means 224 feeds the decoded still image video data from the video decoder 15 to the video encoder 18 via the vide processor 17. As a result, from the video encoder 18, a video signal for displaying a still image is outputted to the display device 20, where a slide show image (for example, a still image of the first file) is displayed.

At the moment that this image starts to be displayed, the next-file-information obtaining means 225 of the system controller 22 starts obtaining the file information of the next file (for example, the second file) (step S6), and simultaneously the display time judging means 227 of the system controller 22 starts counting the display time of the slide show image after the start of its display on the display device 20 (step S8). Then, the display time judging means 227 judges whether or not the display time has reached a predetermined time (step S9).

After the file information of the next file (for example, the second file) is obtained, the next reproducible file judging means 226 of the system controller 22 judges, based on the obtained file information, whether or not the next file is a reproducible file (step S7). If, in step S9, the display time is judged to have reached the predetermined time and in addition if, in step S7, the next file is judged to be a reproducible file based on the file information obtained by the next file information obtaining means 225, the next-file decoding instructing means 228 instructs the video decoder 15 to decode the next file. Thus, the next file is decoded (step S10).

If, in step S9, the display time is judged to have reached the predetermined time, the next image display means 229 of the system controller 22 makes the display device 20 display the next slide show image (for example, the still image of the second file) based on the decoded data (step S11).

If, in step S3, a file is judged to be unreproducible, the file information of the next file is obtained in step S6. If, in step S7, a file is judged to be unreproducible, the file information of the next file is read to obtain the file information thereof, and thereafter, the same steps as described above are performed.

Also after the next slide show image is displayed in step S11, the second next file is read to obtain the file information thereof, and thereafter, the same steps as described above are repeatedly performed.

As described above, in this embodiment, it is possible that, while the display time of a slide show image is being counted, the next file is read in advance so that its image is displayed immediately after the lapse of a set time. Hence, when image files conforming to an image format such as JPEG are displayed in a form of a slide show, images can be switched at regular time intervals irrespective of their file size, and with even display times. This enables the user to enjoy images without feeling any stress.

What is claimed is:

1. An optical disc reproducing apparatus that reproduces information recorded on an optical disc,
wherein a system controller of the optical disc reproducing apparatus controls such that:
while a display time of a slide show image being displayed based on a selected file is counted, a next file is read in advance; and
as soon as the display time has reached a set time, a next slide show image is displayed based on the next file.

2. The optical disc reproducing apparatus of claim 1,
wherein the system controller comprises:
file information obtaining means for reading a selected file to obtain file information thereof;
reproducible file judging means for judging, based on the obtained file information, whether or not the selected file is reproducible;
decoding instructing means for instructing a video decoder to decode the selected file if the selected file is judged to be reproducible;
image display means for making, after the selected file is decoded, a display device display a slide show image based on the decoded data;
next file information obtaining means for starting, at a start of the display of the slide show image, to read a next file to obtain file information thereof;
next reproducible file judging means for judging, based on the obtained next file information, whether or not the next file is reproducible;
display time judging means for judging, by counting a display time after a slide show image started to be displayed on the display device by the image display means, whether or not the display time has reached a predetermined time;
next file decoding instructing means for instructing the video decoder to decode the next file when the display time is judged to have reached the predetermined time and the next file is judged to be reproducible based on the file information thereof obtained by the next file information obtaining means; and
next image display means for making, after the next file is decoded and when the display time is judged to have reached the predetermined time, the display device display a slide show image based on the next decoded data.
